(19) United States
(12) Patent Application Publication
(10) Pub. No.: US 2006/0108226 A1
(43) Pub. Date: May 25, 2006

(54) Method for producing fully ceramic tooth elements having a pre-determined spatial form by means of electrophoresis

(76) Inventor: Stefan Wolz, Bad Sobernheim (DE)

Correspondence Address: FOLEY AND LARDNER LLP;SUITE 500, 3000 K STREET NW, WASHINGTON, DC, 20007, US

(21) Appl. No.: 10/533,666

(22) PCT Filed: Oct. 31, 2003
(86) PCT No.: PCT/DE03/03628

§ 371 Date: May 3, 2005

(30) Foreign Application Priority Data
Nov. 5, 2002 (DE) 102 51 369.4
Dec. 13, 2002 (DE) 102 58 244.0

(51) Int. Cl. A61C 13/00

(52) U.S. Cl. 205/67; 264/16

(57) ABSTRACT

The invention relates to a method for producing fully ceramic tooth elements having a pre-determined spatial form by means of electrophoresis. According to said method, an electroconductive chip or a chip which has been rendered conductive is arranged directly between two stumps of a working model (10, 20) or a structural element, or at a distance therefrom. Said chip (30) can comprise regions (50, 60) of different electrical conductivity and is connected to the positive pole during the electrophoresis. The inventive method can be used to produce structures for bridges, and to apply veneering material to structures. The geometric form of the different regions enables the local current strength and the local material deposition to be regulated, in such a way as to obtain a desired spatial form of the deposit. The thus produced tooth element therefore requires no further extensive secondary work, saving a considerable amount of time. Especially the application of veneering material with a brush is rendered superfluous.

From DE 198 52 740 A1 is known a method for the manufacture of fully ceramic bridge frameworks. According to this method, initially two copings, made for example from an alumina slip, are connected to a bridge pontic made of the same material. The green body thus fabricated is then sintered and glass-infiltrated. Not only do the manufacture and fitting of the bridge pontic require great dexterity, but also the mechanical connection at the sites of contact between the copings and the pontic may not be satisfactory due to structural problems.

Moreover, from DE 100 21 437 A1 is known an electrophoretic method for the manufacture of fully ceramic copings made of alumina, whereby the die of a working model is coated with a foil or separating agent, which is liquid at temperatures in excess of 45° C. and has a lipstick-like consistency at room temperature, a slip is applied to this coating and, after separation from the working model, the slip is dried and baked to form the framework, which is subsequently glass-infiltrated. The coating is applied by using an electrically conductive coating which is immersed in a vessel containing slip and by applying a direct voltage between the vessel and the electrically conductive coating to effect the application of the solid of the slip to the die of the working model.

As is common in ceramic science, the term, “slip”, shall denote a slurry of a ceramic material in an aqueous liquid, although, according to WO 99/50480, there is a biased opinion regarding the use of water as a suspension agent in the manufacture of ceramic copings.

It is therefore the object of the invention defined in claim 1 to refine the electrophoretic procedure of dental technology such that the deposited slip material has a desired spatial shape that requires no or little reworking. In this context it has become evident that the method according to the invention is suitable not only for the manufacture of frameworks but also for the deposition of veneering material in a desired spatial shape.

This object is met by the features of claim 1.

Advantageous embodiments are described in the dependent claims.

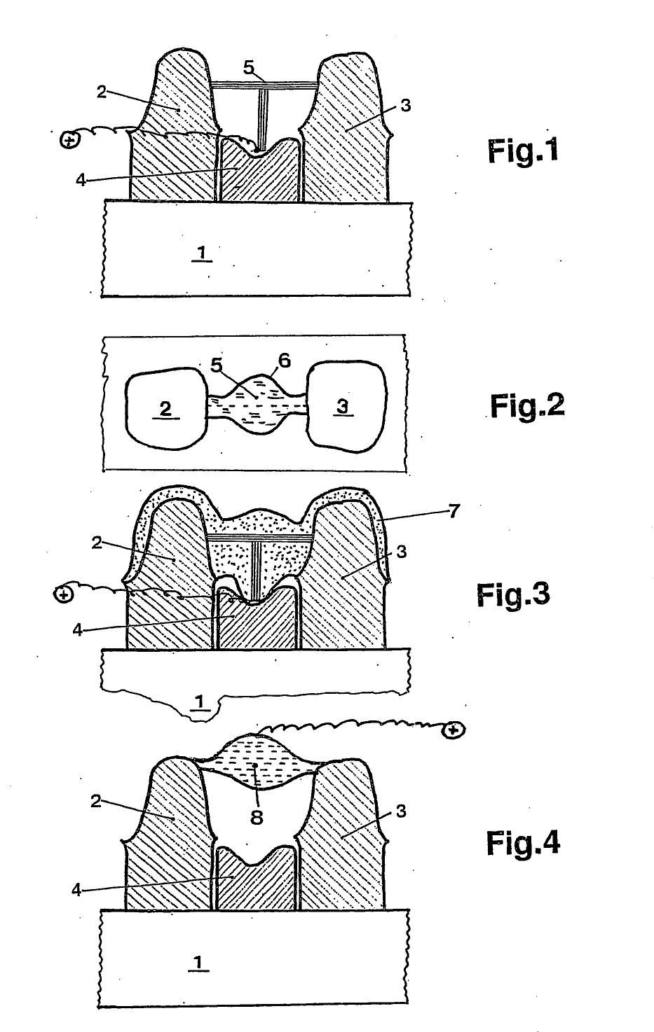

In the following, the invention is illustrated in detail by means of FIGS. 1 to 12:

In the figures:

FIG. 1 shows two tooth stumps in a reception part of the coating machine;

FIG. 2 shows a top view onto FIG. 1;

FIG. 3 shows the tooth stumps of FIG. 1 after coating;

FIG. 4 shows a second embodiment of the electrically conductive chip;

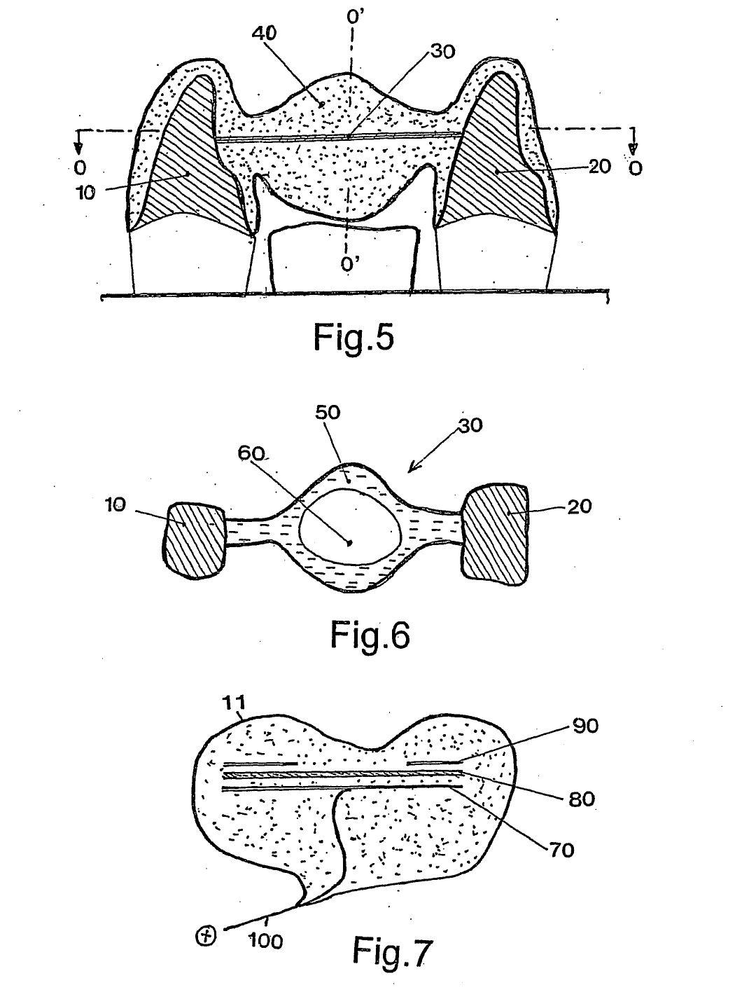

FIG. 5 shows the manufacture of a bridge framework for two tooth stumps;

FIG. 6 shows a section along O-O in FIG. 1;

FIG. 7 shows a section along O′-O′ in FIG. 1;

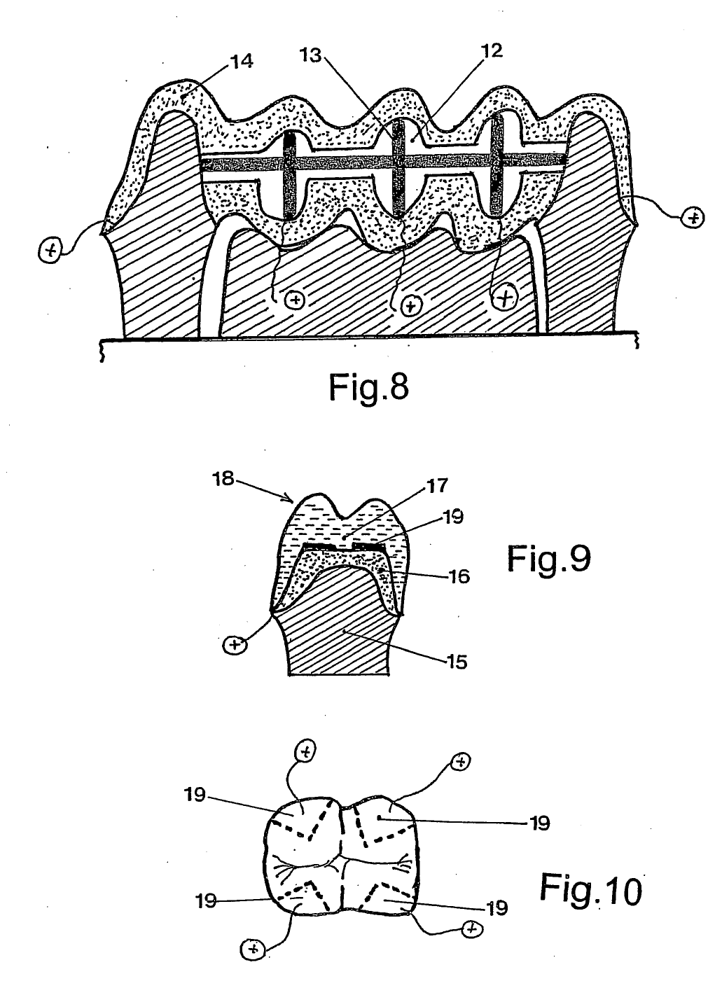

FIG. 8 shows the manufacture of a bridge in the frontal part of the lower jaw;

FIG. 9 shows a section through a premolar tooth;

FIG. 10 top view onto the premolar tooth according to FIG. 9;

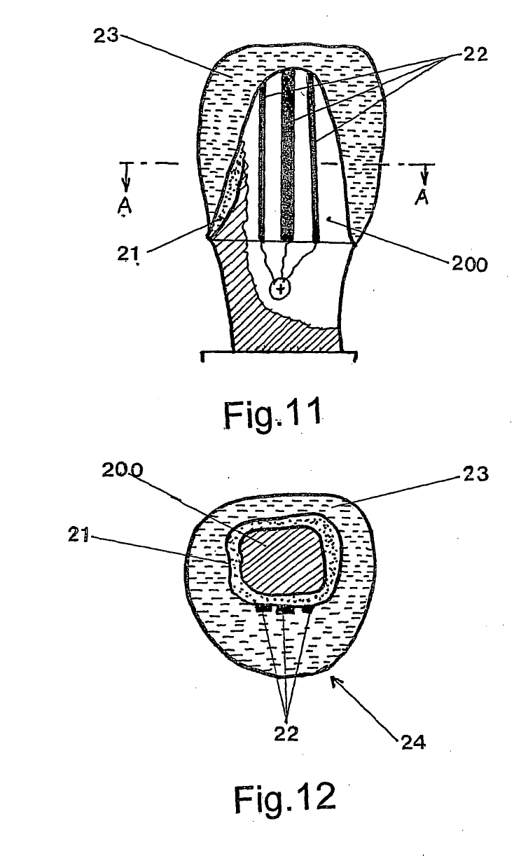

FIG. 11 shows the manufacture of a front tooth; and

FIG. 12 shows a section along A-A in FIG. 11.

The invention shall be illustrated in more detail in the following. FIG. 1 shows a reception part 1, usually made from aluminum, for an electrophoretic coating machine. For the purpose of clarification, all figures are shown rotated by 180°. Inside the machine, the plaster dies 2 and 3 are arranged suspended by being fixed in the reception part 1, for example by means of an embedding mass, whereby an intervening jaw part 4 filling the space of the lost tooth is provided also.

The reference number 5 denotes an electrically conductive chip with a T-shaped cross-section. The chip 5 can be made from a large variety of materials. It is essential for chip 5 to be electrically conductive, though. Suitable materials for the chip shall be mentioned below.

The foot part of the chip is connected to the positive pole of the electrophoresis apparatus.

FIG. 2 shows a top view onto FIG. 1. It is evident from this figure that the roof part of the chip comprises an enlargement 6.

In the machine, a common slip is produced to have a mixing ratio of 30 g alumina powder (manufacturer: Vita), and 5 ml of water and one drop of additive (manufacturer: Vita). The arrangement according to FIG. 1 comprising a chip 5 made of nylon paper is then immersed in this slip after the dies 2, 3 and the chip 5 were made electrically conductive with concentrated saline solution. The application of a voltage of approx. 36 Volt produces an electrical current of 20-40 mA which generates a bridge framework 7, such as is shown in FIG. 3. This framework is then sintered and glass-infiltrated in a conventional fashion. The lead cable is insulated from its site contacting the chip to ensure that the cable is not coated in the process.

During the sintering, the chip 5 burns off completely, but leaves behind a corresponding hollow space, which, after being filled with slip, is then re-sintered in a second sintering process. This hollow space can also be filled by glass during glass infiltration.

A number of options are available if it is desired to prevent the formation of a hollow space as described above. For example, the chip 5 can be made from alumina fibers or wisker. In embodiments of this type, the chip material is simply sintered into the bridge pontic. Another option is provided by a different geometry, as is shown in FIG. 4, in which the chip 8 is placed more or less on top of the dies 2,3. The outside of the chip 8 is insulated such as to prevent the formation of a deposit in this area. The entire lead cable is insulated for the same reason.

As another option, the chip can be fabricated from a material comprising a metal foil between two layers of a fibrous material (e.g. paper). Though, in principle, the use of just a metal foil is also feasible, it has become evident that the strong electrical current leads to the formation of bubbles in this case, which may lead to defects in the material.

It is also evident from the explanations above that the local flow of material and thus the three-dimensional shape of the bridge framework can be influenced strongly by the geometrical shape of the chip. In general, the deposition of material depends on the amplitude of the local electrical current.

FIG. 5 shows the manufacture of a bridge framework as has been described earlier. A chip 30 is arranged between two dies of a working model. As is evident from FIG. 6, the chip 30 comprises an area 60, which is less conductive in contrast to area 50. This is achieved by the chip having a structure as shown in the exploded view of FIG. 7. Herein, the chip 30 comprises a metallic sub-layer 70 made of aluminum 0.05 mm thick, onto which a layer 80 made of nylon paper is applied. Moreover, a layer 90, also made of aluminum foil, is applied onto this nylon paper and provides the electrically more conductive area 50 according to the shape shown in FIG. 6. The sub-layer 70 made of aluminum is connected to the positive pole of the electrophoresis apparatus by means of a lead 100. Initially, the dies 10,20 made of plaster and the chip 30 are made electrically conductive by immersing them in a salt solution. When the bridge material 40 is then applied by means of electrophoresis in a known fashion, the stronger electrical current in the area of the metal foil, i.e. in area 50 and underneath foil 70, effects increased deposition of the material such that after switching-off the electrical current the bridge framework is already provided in the desired shape. In particular, it is possible with this procedure to generate the humps 11 shown in FIG. 7. The veneering material can subsequently be applied to this bridge framework directly after sintering and glass-infiltration.

It is self-evident that the chip comprising areas with different electrical conductivities can be manufactured by a great variety of means. It is possible, for example, to use only one metal foil onto which more or less conductive areas have been applied. Alternatively, as in the example shown above, the base layer can consist for example of nylon paper or a similar, preferably non-textile, layer onto which a metallic structure is applied, for example by screen printing. Since the technology known from semi-conductor board manufacturing can be applied to this purpose, it is not difficult to fabricate even very complicated shapes.

FIG. 8 shows the manufacture of a multiple-membered bridge framework in the lower jaw. An electrically conductive area 13 is applied to the chip 12, which is adapted to the shape of the pontic intended to replace three teeth. A layer of material 14 is then deposited by means of electrophoresis and already possesses the desired spatial shape.

FIG. 9 shows the manufacture of a premolar tooth. A ready-made coping 16 to be veneered with veneering material 17 resides on the working die 15. A chip, which is not shown in any detail, is then placed on the coping 16 and comprises metallic areas 19, whose triangular shape is clearly evident from FIG. 10. During the deposition of veneering material from a slip, four humps 18, typical of a premolar tooth, are formed above the four metallic areas 19. Since the shrinking upon sintering is accounted for in the application of the veneering material, the premolar tooth possesses the desired shape after sintering already such that no or little reworking is required.

FIGS. 11 and 12 show the manufacture of a front tooth. A ready-made coping 21 resides on a plaster die 200, whereby the front side of the coping bears a chip, made of nylon paper for example. This chip comprises three metallic strips 22 with the strip in the middle being somewhat wider than the others. In the course of the electrophoresis, this causes the applied veneering material 23 to possess the desired thickness and curvature 24 on the front side in this step already such that only some fine-working is necessary to finish the tooth.

In the two embodiments according to the invention shown in FIGS. 9 to 12, the chip is either placed on a part of the framework (coping 16 in FIG. 9 or coping 21 in FIG. 11). However, it is also feasible to arrange the chip at a distance from the coping. For this purpose, it is adapted to the outer contour of the veneering material prior to the application of the veneering material such that only the space in between the coping and the chip is filled during the electrophoresis such that it then corresponds exactly to the desired spatial shape of the veneer. In this case, the chip is electrically conductive only on the side facing the coping, but insulated on the outside, and thus has a shape function in addition to its electrical current supply function.

It is self-evident that this principle can also be implemented in the manufacture of frameworks.

For obvious reasons, the chips cannot be removed after the application of the material but rather remain in place during the sintering except where the chip is attached as a form on the outside. However, the experiments conducted thus far have shown that it is not disadvantageous for the coping to remain in place. In as far as aluminum is used, the substance is simply oxidised to alumina during the sintering process and does not interfere with the procedure. Organic material, e.g. nylon, combusts leaving virtually no residue. The hollow space occupied by the chip is filled-in completely during the glass-infiltration and, in addition, provides the advantage that it serves as a gas escape channel prior to being filled out. Thus, no reduction of mechanical strength is detectable in the finished state of the material.

Therefore, the present invention provides another step towards the cost-efficient supply of high-quality fully ceramic dental restorations to patients.

1. Method for producing fully ceramic tooth elements having a pre-determined spatial form by means of electrophoresis, characterized in that an electrically conductive chip or chip which has been rendered electrically conductive is arranged directly on a working model or on a part of the framework, whereby the chip can comprise regions of different electrical conductivity and is connected preferably to the positive pole during the electrophoresis.

2. Method according to claim 1, characterized in that the framework material is being deposited.

3. Method according to claim 1, characterized in that the veneering material is being deposited.

4. Method according to claim 1, characterized in that the chip is a synthetic paper made electrically conductive by means of a salt solution.

5. Method according to claim 1, characterized in that the areas of lower electrical resistance are generated by means of aluminum foil.

6. Method according to claim 2, characterized in that an alumina or zirconia slip is used.

7. Method according to claim 4, characterized in that nylon is used as the chip material.

8. Method according to claim 1 [[or 2]], characterized in that the chip comprises alumina fibers, in particular wiskers.

9. Method according to claim 1, characterized in that an electrically conductive foil, e.g. made of aluminum, is arranged between two fibrous layers of the chip.

10. Method according to claim 1, characterized in that the chip is made electrically conductive by means of saline solution.

11. Method according to claim 1, characterized in that the chip has a T-shaped cross-section.

12. Method according to claim 1, characterized in that the chip is wider in the middle than in the area of the dies.
